(19) United States
(12) Patent Application Publication
(10) Pub. No.: US 2024/0394820 A1
(43) Pub. Date: Nov. 28, 2024

(54) MODULAR SCREENING APPARATUS AND METHOD

(71) Applicant: The Government of the United States of America, as represented by the Secretary of Homeland Security, Washington, DC (US)

(72) Inventor: Vanessa Couch, El Segundo, CA (US)

(73) Assignee: The Government of the United States of America, as represented by the Secretary of Homeland Security, Washington, DC (US)

(21) Appl. No.: 18/624,941

(22) Filed: Apr. 2, 2024

Related U.S. Application Data
(60) Provisional application No. 63/468,893, filed on May 25, 2023.

(51) Int. Cl. G06Q 50/26

(52) U.S. Cl. CPC G06Q 50/265

(57) ABSTRACT

In an example, a mobile screening method includes: screening people and their properties which include at least one of carry-on properties or shipped properties, using a mobile screening system which includes a plurality of modular portable screening units, each modular portable screening unit being selected from the group consisting of (i) a people security screening apparatus, (ii) a people security screening apparatus and a carry-on property security screening apparatus, and (iii) a shipped property security screening apparatus.

### CROSS-REFERENCE TO RELATED APPLICATIONS

The application is a nonprovisional of and claims the benefit of priority from U.S. Provisional Patent Application No. 63/468,893, filed on May 25, 2023, entitled MODULAR SCREENING APPARATUS AND METHOD, the disclosure of which is incorporated by reference in its entirety.

### SUMMARY STATEMENT OF GOVERNMENT INTEREST

The present invention was made with support from the United States Department of Homeland Security (DHS) and by an employee of DHS in the performance of their official duties. The U.S. Government has certain rights in this invention.

### FIELD

The discussion below relates generally to screening of people and objects and, more particularly, to methods and systems for modular screening of people and objects for permission-based activities.

### BACKGROUND

Large events, special events, natural disasters, and non-routine events cause security checkpoints such as TSA (Transportation Security Administration) checkpoints at airports to become backlogged or inaccessible. Long lines create a nightmare for patrons or passengers and can present a host of opportunities for individuals with ill-intent. Airports, arenas, stadiums, and other venues often have limited space and do not have room to expand or set up additional checkpoints. It also may be financially infeasible to put in additional resources for occasional and/or short duration events.

These events also cause potential issues for city/state government agencies and the host organization due to the large volumes of people and the security threat/concern those people and their belongings may cause.

### SUMMARY

Embodiments of the present invention are directed to a modular, self-contained, portable/mobile screening system containing screening systems such as TSA approved screening equipment. The screening system can be deployed as a single unit, or as multiple units such as modular units, allowing for flexible configurations. The portable screening system may be equipped with the latest scanning technologies for passenger and/or baggage screening and can be modified or customized based on the specific use of the customer. A screening system that is not permanently placed at a fixed location but can be moved from one location to another is portable. A screening system that can be combined with, removed from, or otherwise rearranged in, an overall screening arrangement to meet variable needs or demands, is modular.

In accordance with an aspect, a mobile screening system comprises: a plurality of modular portable screening units, each modular portable screening unit being selected from the group consisting of (i) a people security screening apparatus, (ii) a people security screening apparatus and a carry-on property security screening apparatus, and (iii) a shipped property security screening apparatus.

Another aspect is directed to a mobile screening method which comprises screening people and their properties which include at least one of carry-on properties or shipped properties, using a portable screening system which includes a plurality of modular portable screening units, each modular portable screening unit being selected from the group consisting of (i) a people security screening apparatus, (ii) a people security screening apparatus and a carry-on property security screening apparatus, and (iii) a shipped property security screening apparatus.

In accordance with yet another aspect, a mobile screening method comprises moving one or more modular screening vehicles to a temporary security screening area, each of the one or more modular screening vehicles including one of a plurality of modular screening units, each modular screening unit being selected from the group consisting of (i) a people security screening apparatus, (ii) a people security screening apparatus and a carry-on property security screening apparatus, and (iii) a shipped property security screening apparatus. The method further comprises admitting into the one or more modular screening vehicles, the people and their properties which include at least one of carry-on properties or shipped properties, into the one or more modular screening vehicles through an entrance of each of the one or more modular screening vehicles for security screening in the one or more modular screening vehicles; screening the people and their properties in the one or more modular screening vehicles using the modular screening units; and discharging the people and their properties that are screened and approved from the one or more modular screening vehicles through an exit of each of the one or more modular screening vehicles to a secured area after passing the security screening.

Other features and aspects of various examples and embodiments will become apparent to those of ordinary skill in the art from the following detailed description which discloses, in conjunction with the accompanying drawings, examples that explain features in accordance with embodiments. This summary is not intended to identify key or essential features, nor is it intended to limit the scope of the invention, which is defined solely by the claims.

### BRIEF DESCRIPTION OF THE DRAWINGS

The attached drawings help explain the embodiments described below.

FIG. 1 shows an example of a self-contained, portable screening system for a one-lane checkpoint to screen people in a people screening apparatus and accessible property in a property screening apparatus.

FIG. 2 shows an example of a set or system of three self-contained, portable screening units including two lanes for screening people in a people screening apparatus and accessible property in a property screening apparatus and one lane for screening checked luggage in a checked luggage screening apparatus.

FIG. 3 shows an example of a modular portable security screening system mounted on or built into a trailer on a land or ground vehicle such as a truck.

FIG. 4A shows an example of a modular portable security screening system having a modular security screening unit disposed in an air vehicle such as a VTOL or an eVTOL vehicle.

FIG. 4B shows an example of a modular portable security screening system having a modular security screening unit disposed in a water vehicle such as a ship.

FIG. 5 shows an example of a system or setup of two modular portable security screening units for screening of people in a people screening apparatus and accessible property in a property screening apparatus at one or more portable screening systems located in a temporary security screening area between a public area and a temporary sterile location or area and transporting the screened and approved people and accessible property from the temporary sterile location to a destination in a sterile transport vehicle.

FIG. 6 shows an example of a system or setup of two modular portable security screening units for screening of people in a people screening apparatus and accessible property in a property screening apparatus at one or more portable screening systems located in a temporary security screening area between a public area and a temporary sterile location or area, providing a temporary sterile waiting area or shelter or room, and transporting the screened and approved people and accessible property from the temporary sterile location to a destination in a sterile, secured transport vehicle.

FIG. 7 is a diagram illustrating an example of a screening experience from arrival to check-in, screening, waiting, and secure transport to airport departure for boarding.

FIG. 8 is a flow diagram illustrating an example of the mobile screening method.

### DETAILED DESCRIPTION

A number of examples or embodiments of the present invention are described, and it should be appreciated that the present invention provides many applicable inventive concepts that can be embodied in a variety of ways. The embodiments discussed herein are merely illustrative of ways to make and use the invention and are not intended to limit the scope of the invention. Rather, as will be appreciated by one of skill in the art, the teachings and disclosures herein can be combined or rearranged with other portions of this disclosure along with the knowledge of one of ordinary skill in the art.

Embodiments of the present invention are directed to a modular, self-contained, portable/mobile screening system that can be deployed as a single unit or as multiple units. The scanning equipment in the units can be customized and the units can be modularly assembled to achieve flexible configurations.

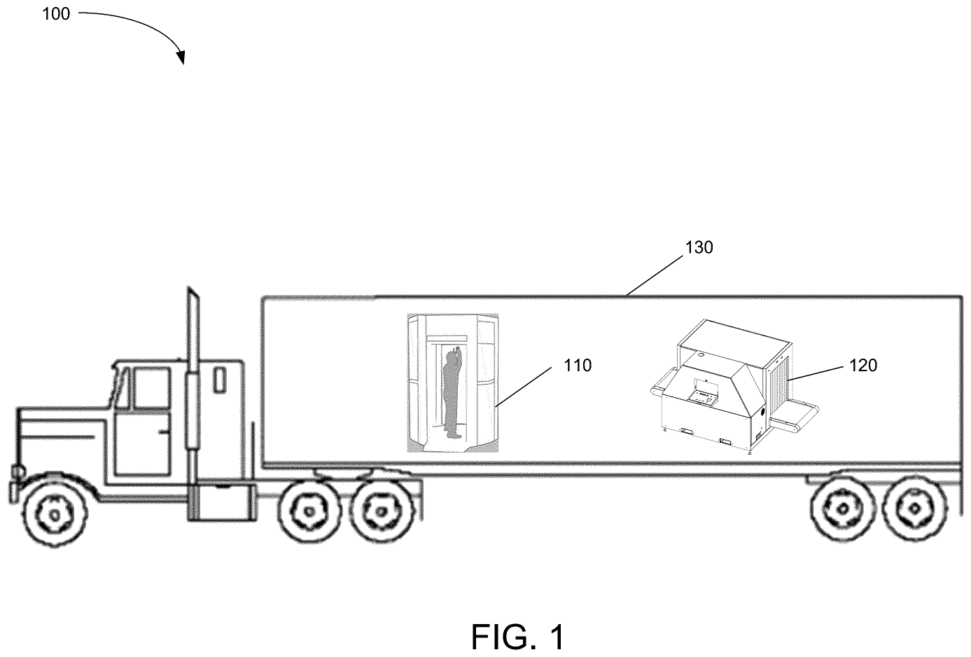

FIG. 1 shows an example of a self-contained, portable screening system 100 for a one-lane checkpoint to screen people in a people screening apparatus 110 and accessible property (including carry-on baggage) in a property screening apparatus 120. As shown, the portable screening system 100 includes one security screening unit disposed in a security screening vehicle 130 which is a land vehicle such as a truck or trailer.

In another embodiment, the portable/mobile screening system 100 may be used for screening people only by removing the property screening apparatus 120 or simply not using the property screening apparatus 120.

In another embodiment, the portable screening system 100 may be used for screening property only such as checked luggage or shipped property by removing the people screening apparatus 110 or simply not using the people screening apparatus 110. The property screening apparatus 120 is presumed to be adaptable for screening larger items such as checked luggage using x-ray or the like. Alternatively, a different property screening apparatus specifically configured for screening checked luggage or shipped items (i.e., items other than carry-on luggage or other accessible property) may be installed instead.

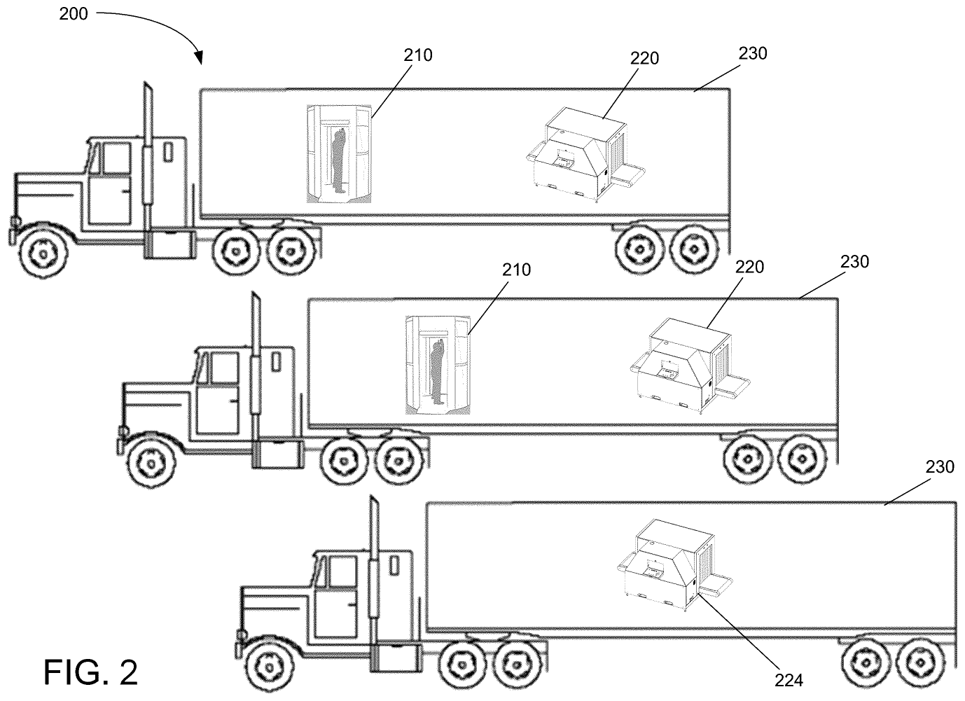

FIG. 2 shows an example of a set or system 200 of three self-contained, portable screening units including two lanes for screening people in a people screening apparatus 210 and accessible property in a property screening apparatus 220 and one lane for screening checked luggage and shipped items in a checked luggage screening apparatus 224 (which may be the same or different from the property screening apparatus 220).

The portable screening system 200 may include a plurality of modular portable security screening units (FIG. 2 shows three such units). Each modular portable screening unit may be selected from the group consisting of (i) a people security screening apparatus 210, (ii) a people security screening apparatus 210 and a carry-on property security screening apparatus 220, and (iii) a shipped property security screening apparatus 224.

Each modular portable/mobile security screening unit may be disposed in a security screening vehicle 230 which is a land vehicle such as a trailer. The units can be powered by batteries, onboard generators, solar power, by power supplied at the location, or by future developed power supplies.

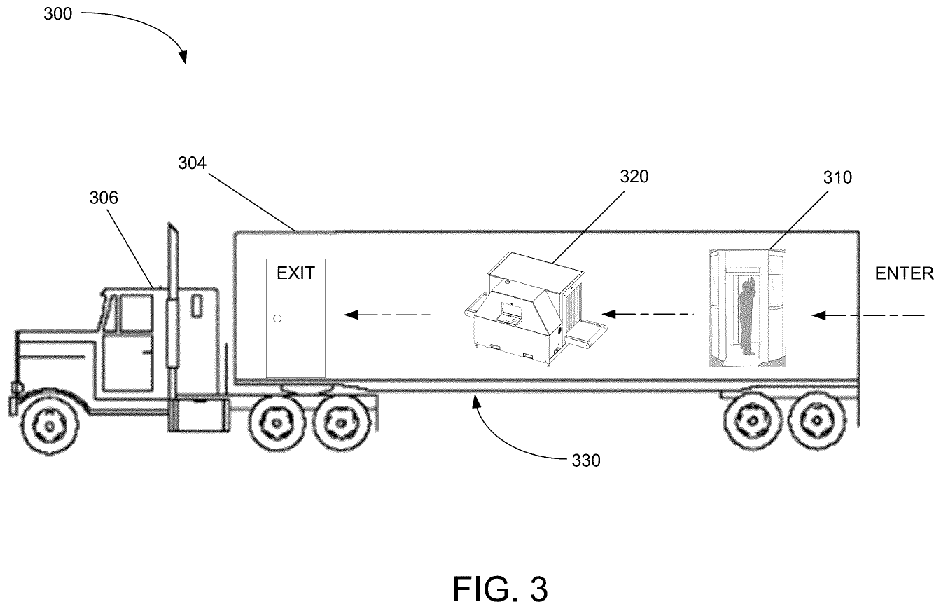

FIG. 3 shows an example of a modular portable security screening system 300 mounted on or built into a trailer 304 on a land or ground vehicle such as a truck 306. The portable/mobile screening system shown is for screening people in a people screening apparatus 310 and accessible property in a property screening apparatus 320. The trailer 304 and truck 306 form a security screening unit in the form of a security screening vehicle 330 having an entrance and an exit. The screening takes place inside the security screening vehicle 330. The entry and exit can be arranged in any suitable manner for a flow of people and properties to be screened that is sensible and efficient. The screened and approved people and properties that pass the security screening will leave the security screening area through the exit and proceed to a secured area. Those that do not pass the security screening will return to the public area as screened and rejected people and properties and prevented from entering the secured area.

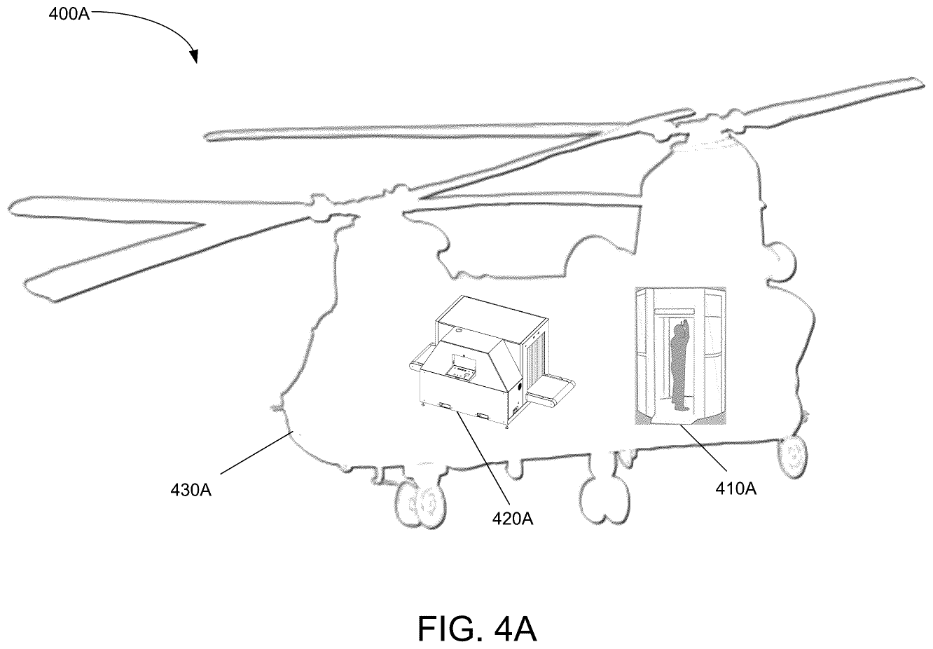

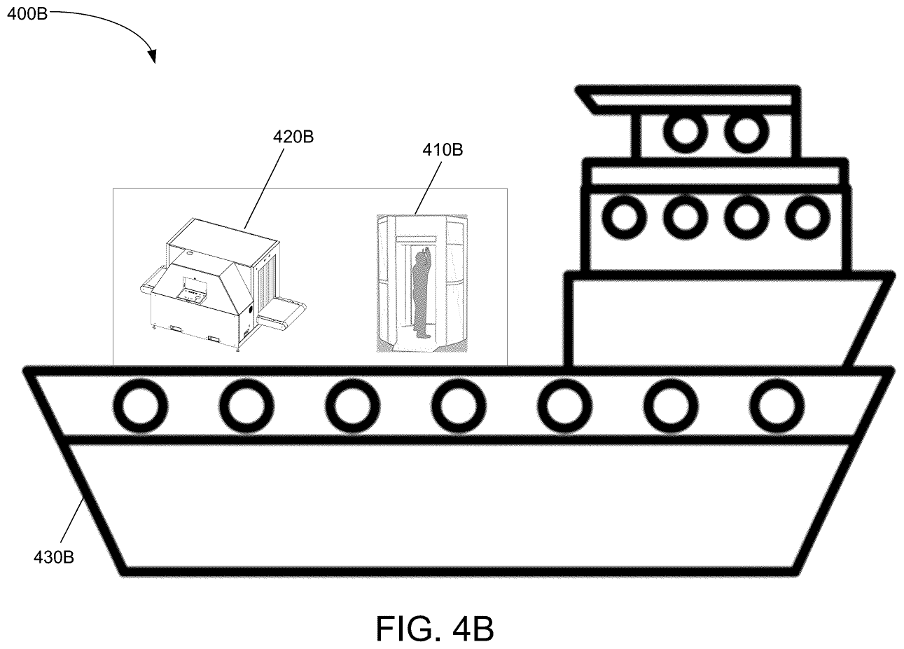

FIG. 4A shows an example of a modular portable security screening system 400A having a modular security screening unit disposed in an air vehicle such as a VTOL or an eVTOL vehicle. The portable/mobile screening system shown is for screening people in a people screening apparatus 410A and accessible property in a property screening apparatus 420A. The portable screening system 400A may be flown into an area that may not be accessible by a land vehicle. In a specific embodiment, the people screening apparatus 410A and property screening apparatus 420A may be mounted on or built into the VTOL/eVTOL vehicle as a security screening vehicle 430A or unit.

FIG. 4B shows an example of a modular portable security screening system 400B having a modular security screening unit disposed in a water vehicle such as a ship. The portable/mobile screening system shown is for screening people in a people screening apparatus 410B and accessible property in a property screening apparatus 420B. The portable screening system 400B may be sailed into an area that may not be accessible by a land vehicle. In a specific embodiment, the people screening apparatus 410B and property screening apparatus 420B may be mounted on or built into the water vehicle as a security screening vehicle 430B or unit.

Once screened and approved, passengers either take a sterile, secured transport vehicle to their destination(s), if located separate from the portable screening system, or take a walkway into the event/venue if they are co-located. The walkway may include one or more of a fixed or stationary path, a moving walkway, and an escalator. In the airport use case, passengers would be permitted to bypass the traditional or fixed screening checkpoints. Checked luggage would be secured and transported to the airport to be inducted into the baggage system.

In an example involving air travel, the modular portable screening unit is disposed in a land vehicle, air vehicle, or water vehicle. When additional TSA resources are needed (e.g., due to seasonal air travel, special events, naturals disasters, etc.), TSA can deploy modular portable screening units and staff them through the National Deployment Force (NDF) or in coordination with the local FSD (Federal Security Director).

The modular screening process starts with a request or an offer. A customer may request the TSA support through TSA Cares or at the TSA Contact Center, or the TSA may reach out to an organization to offer screening services. A call is set up with local FSD to determine resources. If unable to provide local support, the customer may contact the NDF office and will need to coordinate lodging. The parties involved will coordinate site requirements (e.g., dedicated space, power, etc.), coordinate logistics for transporting screened and approved passengers to the airport (e.g., bus, Ground Security Coordinator (GSC), etc.), and determine if checked luggage screening is required. The TSA will deploy the mobile checkpoint from a secure facility to the location for modular mobile screening.

The next phase is set up. One or more modular security screening vehicles such as trucks arrive at the location for modular mobile screening. The modular security screening vehicle may include any or all of the following: CAT (Computerized Axial Tomography) scanner, AIT (Advanced Imaging Technology) scanner, CT (Computerized Tomography) X-ray device, ETD (Explosives Trace Detector) scanner, BLS (Basic Life Support) equipment, search table, generator, WiFi, secure phone to central dispatch, duress alarm to central dispatch, laptop, portable tables, bins, portable fences, portable lights, extension cords, folding chairs, stanchions, required screening signs, PPE (Personal Protective Equipment), pop up tents for shade or to protect from rain, K9 panels, safety vests, pop up tent with side panels for private screening, etc.

The screening operators or personnel will establish a “command center” with the local customer, establish a sterile area and a public area utilizing portable fences, set up a queue in front of the screening vehicles along with TSA signs and tables, set up a re-composure area in the sterile area (including tables, chairs, etc.), establish a private screening area, and establish a breakroom with potable water and restroom which may be a portable/mobile unit.

For screening, passengers will each arrive at the location, enter the queue, present an ID (identification document) to a TSA Officer at the CAT machine, enter the screening vehicle via a ramp at the entrance of the vehicle, place items to be screened in a tray and submit them to the x-ray for screening, and submit themselves for screening through the AIT (or for pat down if AIT screening is declined). If needed, the passenger may be subjected to secondary screening or may be escorted with any carry-on items to a search table for the screening of accessible property. At the end of the screening, the passengers will collect cleared items and proceed to the exit out the back ramp of the vehicle into the re-composure area and then proceed to a sterile, secured transport vehicle for transport to the terminals.

The portable screening process may be integrated into the airport environment as follow. The customer will provide the sterile transport bus and driver. The driver is SIDA (Security Identification Display Area) badged for the airport, has airfield driving privileges, and is permitted to escort passengers on the airfield per the Airport Security Program. Each bus undergoes a physical search prior to loading passengers. If the same bus is utilized more than once, the bus will be inspected each time. The search will be documented and retained for 30 days. The form will include the date, time, bus number, areas inspected, driver's name and SIDA badge number, and the name of the person conducting the search (if different from the driver). All compartments on the exterior of the bus that are accessible by passengers will be searched and then sealed with a tamper evident seal. Areas inside the bus that could be compromised by repeated physical search can be sealed with tamper evident seals. In the event a tamper evident seal is broken or shows signs of tampering, that area will be inspected. Once the search is completed, the passengers can access and board the bus with their carry-on items. If any carry-on items cannot fit inside the bus, they will be placed in a designated compartment. Only TSA screened and approved items may be placed in this compartment. A tamper evident seal will be placed on the compartment.

When the sterile transport bus is ready to depart for transport to the airport, the following will occur. Either a GSC will ride with the bus, ensuring nobody else enters the bus once it has left the checkpoint or the GSC will place a tamper evident seal on the outside of the bus door. The seal will be recorded and the record retained for 30 days. The bus will enter the airport airfield through a designated vehicle post. Current security procedures will be applied per the Airport Security Program. If the bus is sealed with a security seal and the bus door needs to be opened, the seal will be verified prior to entering the airfield. The bus continues to the designated drop off location(s). Upon arrival, the passengers will exit the bus and enter the terminal through a pre-designated door directly into a secured area of the airport. Because the passengers have already been screened and approved by TSA, they can proceed directly to their aircraft, lounge, or gate areas. If at any point there is a break in the chain of custody of the passengers, there are mechanical issues with the bus, the bus is involved in an accident, there is a medical emergency, or any other event occurs that deviates from the prescribed provisions above, the bus will divert to the public side of the airport and drop the passengers at the terminal to be rescreened by TSA.

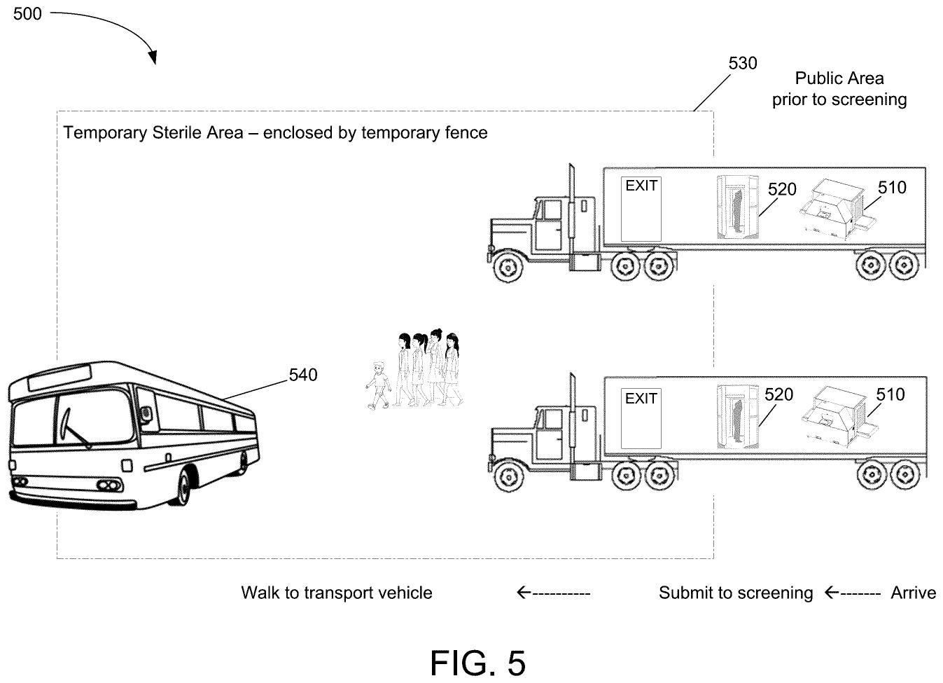

FIG. 5 shows an example of a system or setup of two modular portable security screening units for screening of people in a people screening apparatus and accessible property in a property screening apparatus at one or more portable screening systems located in a temporary security screening area between a public area and a temporary sterile location or area and transporting the screened and approved people and accessible property from the temporary sterile location to a destination in a sterile, secured transport vehicle. The modular portable screening units of the portable/mobile screening system 500 may be moved using a vehicle (land, air, or water) and placed in a temporary security screening area between the public area and the temporary sterile area 530. In the embodiment shown, the modular screening vehicles are positioned between the public area and the temporary sterile area 530 and serve as the temporary security screening area.

The temporary sterile area 530 may be connected via a walkway to a post-screening destination location to which the people can walk. Alternatively, the screened and approved people and properties may be transported from the temporary sterile area 530 using a secured transport vehicle to the post-screening destination location. The post-screening destination may be a venue (e.g., sports arena, stadium, etc.), a park such as an amusement park, an air travel boarding area, a ground transportation boarding area, a water travel boarding area, a building such as an office building, a landmark, or a lodging establishment. The screened and approved people and properties may be directed to bypass a permanent security screening area for screening people and properties to the post-screening destination location.

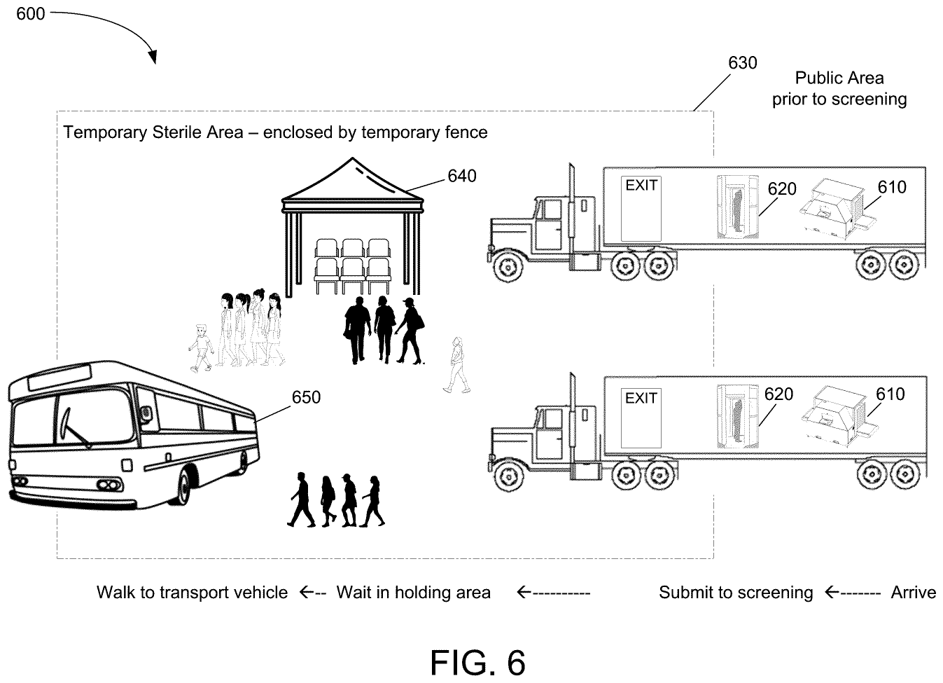

FIG. 6 shows an example of a system or setup 600 of two modular portable security screening units for screening of people in a people screening apparatus 610 and accessible property in a property screening apparatus 620 at one or more portable screening systems located in a temporary security screening area between a public area and a temporary sterile location or area 630, providing a temporary sterile waiting area or shelter or room 640, and transporting the screened and approved people and accessible property from the temporary sterile location 630 to a destination in a sterile, secured transport vehicle 650. The waiting area 640 can provide a more comfortable space for the people to wait for the transportation by protecting them from the exterior elements and providing them with various amenities typically found in airport lounges or the like.

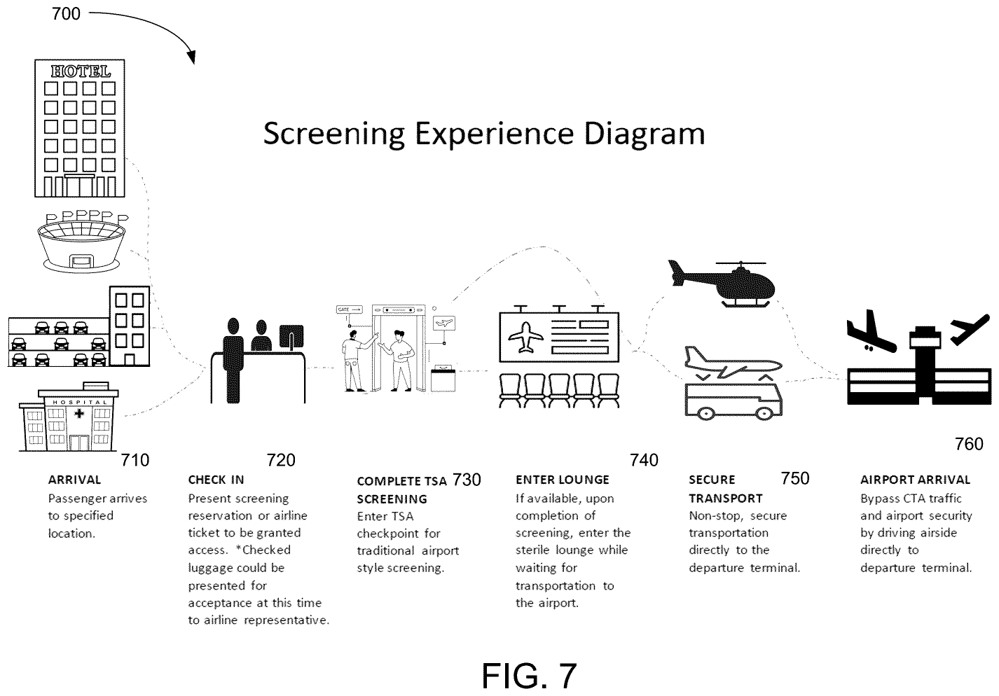

FIG. 7 is a diagram 700 illustrating an example of a screening experience from arrival 710 to check-in 720, screening 730, waiting 740, and secure transport 750 to the airport for boarding 760. At arrival 710, a passenger arrives at a specified location. At check-in 720, the passenger presents a screening reservation or airline ticket to be granted access. In addition, checked luggage could be presented for acceptance at this time to an airline representative. At screening 730, the passenger enters a checkpoint (e.g., TSA checkpoint) for screening such as traditional airport style screening. At waiting 740, upon completion of screening 730, the passenger enters a waiting area or room such as a sterile lounge if available while waiting for transportation to airport arrival 760 for boarding. At secure transport 750, the passenger takes non-stop, secure transportation directly to the departure terminal 760. For the airport arrival 760, the passenger on the secure transportation vehicle bypasses CTA traffic and airport security, for instance, by driving airside directly to the departure terminal for boarding.

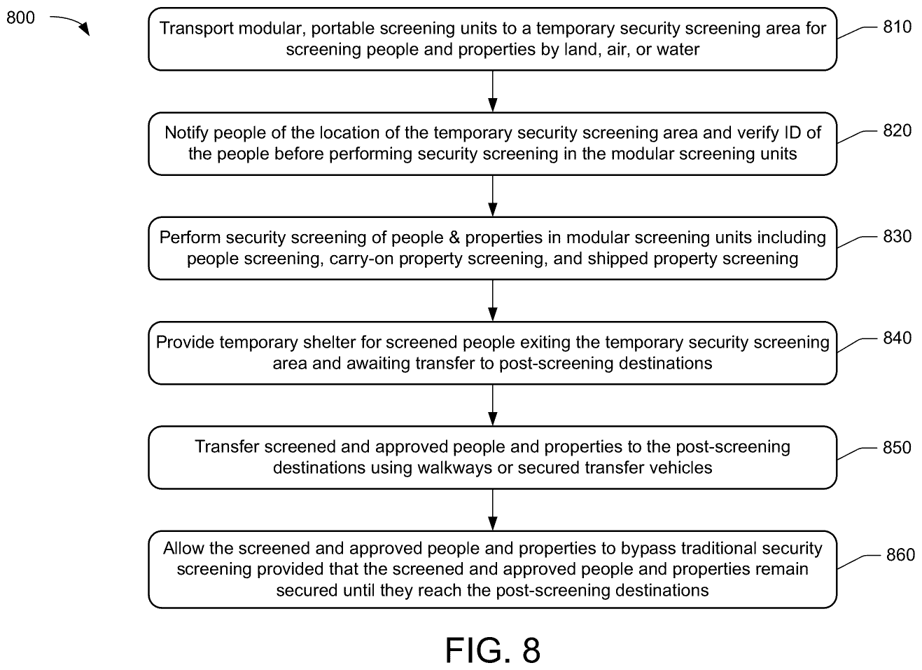

FIG. 8 is a flow diagram illustrating an example of the mobile screening method 800. In step 810, one or more modular, portable screening units are transported to a temporary security screening area for screening people and properties by land, air, or water. Step 820 involves notifying people of the location of the temporary security screening area and verifying ID of the people before performing security screening in the modular screening units. Step 830 involves security screening of people and properties in the modular screening units including people screening, carry-in property screening, and shipped property screening. In step 840, temporary shelter is provided for screened people exiting the temporary security screening area and awaiting transfer to post-screening destination(s). Step 850 involves transferring the screened and approved people and properties to the post-screening destination(s) using walkways or secured transfer vehicles. Step 860 allows the screened and approved people and properties to bypass traditional security screening, provided that the screened and approved people and properties remain secured until they reach the post-screening destination(s).

### Use Case 1—Natural Disaster/Man-Made Disaster

People need to be evacuated safely from an area impacted by a natural disaster. Portable screening systems can be deployed to the disaster location. The portable/mobile screening systems can serve as supplemental checkpoints or can replace traditional screening checkpoints if they are damaged as a result of the disaster.

### Use Case 2—Large Public Event/Special Event (Super Bowl, Olympics, etc.)

Large/special events may require screening prior to entry but it may not be practical or feasible to provide a setup with the necessary resources to conduct the proper screening. Portable screening systems can be deployed to supplement screening or serve as temporary, primary screening locations.

In addition, these events can cause additional strain to the airport environment because they have to process an unusually high number of passengers in a short amount of time using the same limited resources. To alleviate the problem, portable screening systems can be deployed at the event venue around the closing of the event. Passengers and their luggage can be screened as they exit the event and then transported via a sterile vehicle to the airport for departure.

### Use Case 3—Peak Travel Season/Seasonal Travel

During high travel season, surges in passengers from cruise ships and vacation packages can cause airports to become overtaxed with spikes in the influx of passengers. Portable screening systems can be deployed to an area away from the crowded airport for screening the passengers and luggage. For example, a portable/mobile screening system may be deployed at a cruise terminal and passengers can be screened onsite and then transported via a sterile vehicle to the airport for departure.

### Use Case 4—Cruise Terminal

Portable screening systems can also be used as the primary or supplemental screening areas outside a cruise terminal prior to embarking on a cruise.

### Use Case 5—Airport Construction

When an airport needs to renovate a terminal, a portable screening system may be deployed to offset the loss of the fixed or stationary screening checkpoint of the terminal under renovation.

### Use Case 6—Advanced Air Mobility (AAM)

Advanced Air Mobility (AAM) integrates new transformational aircraft designs and flight technologies into existing and modified airspace operations. With the impending introduction of eVTOL/VTOL and AAM into the travel market, a portable screening system may be deployed to screen passengers and objects at locations prior to boarding an eVTOL/VTOL, or prior to the eVTOL/VTOL entering the airport for boarding. This can offset the need to build permanent screening facilities for this new market.

### Use Case 7—Hotel/Convention Center

Venues may decide to have screening locations on site as a perk for their clientele, or to provide screening prior to entering an event. Mobile screening systems offer a feasible and efficient solution.

### Use Case 8—Theme Parks

Theme parks already screen people and accessible property for guests entering the properties. Portable/mobile screening systems may supplement or replace the screening resources available at the parks. Additionally, theme parks may choose to offer airport style screening at the park exits so that departing passengers may arrive to the airport already screened and approved and may thus bypass traditional screening. The use of mobile screening system to screen departing passengers at the park exits can help decrease wait times and congestions at the airports.

### Use Case 9—Secret Service/Law Enforcement Supported Events

During high profile events, portable screening systems can be deployed as a temporary mobile/portable resource to aid in the screening of large crowds.

### Methodology—Order of Events

1) The passenger/client/person is notified (by airline, airport, venue host, etc.) in advance of the location of the temporary portable/mobile screening checkpoint.

2) The person arrives at the screening location.

3) If applicable, the person will have their identity and/or reservation/admission verified. The people and their properties will not pass security and be rejected if their identities cannot be verified.

4) If applicable, the person will tender the checked luggage for screening. The checked luggage will be screened in the portable screening system (if this option is selected) and transported to the airport. If the checked luggage portable screening system is not selected, the checked luggage can be collected and screened at the airport.

5) The person will proceed through the portable/mobile screening system and be subject to all screening technologies.

6) Upon exiting the portable screening system, the passenger will:
a. board a sterile, secured transport vehicle,
b. stay in a sterile lounge or waiting area, later followed by a sterile, secured transport vehicle, or
c. walk into the event/facility/venue.

7) If a secured transport vehicle is used, the secured transport vehicle will drop the person/passenger at the event/facility/venue/airport in a post-security screening location.

If for any reason there is a breach in security or an alarm cannot be cleared, notifications will be made and the person/luggage will not be allowed entry. For airport passengers and/or their luggage, they will be taken to the traditional TSA location at the airport.

Portable screening systems will allow operators to reduce long wait times caused by large, infrequent, or disruptive events and screen people and property away from traditional screening locations. Portable screening systems will improve the customer experience by allowing people to be screened at a designated location and bypass crowded checkpoints, all without reducing security. Portable screening systems allow operators to supplement their current security setup, enhance their security, or create security where it was previously non-existent or lacking.

Portable/mobile screening systems allow for quick, dynamic deployment of mobile screening assets to events in need of people and/or property screening. Because the security screening units are self-contained, the operators can maintain a controlled, sterile environment. As the screening units are modular, clients can pick the type of setup they need (person only screening, person and accessible property, and/or checked luggage or shipped property).

In the airport environment, portable security units will increase the overall security of the airport by removing soft targets from the non-sterile side of the airport, while pushing the security envelope further from the airport. Portable screening systems will allow for passengers to spend more time (and money) in the lounges, restaurants, and retail stores rather than spending their time waiting in line to go through the screening checkpoint.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

Certain attributes, functions, steps of methods, or sub-steps of methods described herein may be associated with physical structures or components, such as a module of a physical device that, in implementations in accordance with this disclosure, make use of instructions (e.g., computer executable instructions) that are embodied in hardware, such as an application specific integrated circuit, or that may cause a computer (e.g., a general-purpose computer) executing the instructions to have defined characteristics. There may be a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an API. In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

The claims define the invention and form part of the specification. Limitations from the written description are not to be read into the claims.

An interpretation under 35 U.S.C. § 112 (f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

1. A mobile screening system comprising one or more vehicles:
(a) if the mobile screening system includes only one vehicle, the vehicle including a plurality of modular screening units built into the vehicle, each modular screening unit being selected from the group consisting of (i) a people security screening apparatus, (ii) a people security screening apparatus and a carry-on property security screening apparatus, and (iii) a shipped property security screening apparatus; and
(b) if the mobile screening system includes a plurality of vehicles, each vehicle of the plurality of vehicles including one or more modular screening units built into said each vehicle, each modular screening unit being selected from the group consisting of (i) a people security screening apparatus, (ii) a people security screening apparatus and a carry-on property security screening apparatus, and (iii) a shipped property security screening apparatus.

2. The mobile screening system of claim 1,
wherein the people security screening apparatus, the carry-on property security screening apparatus, and the shipped property security screening apparatus are TSA approved.

3. The mobile screening system of claim 1,
wherein each vehicle comprises one of a land vehicle, an air vehicle, or a water vehicle.

4. The mobile screening system of claim 1,
wherein each vehicle includes an entrance for people to enter for security screening and an exit for people to proceed to a secured area after passing the security screening.

5. The mobile screening system of claim 1,
wherein each vehicle includes at least one of a CAT (Computerized Axial Tomography) scanner, an AIT (Advanced Imaging Technology) scanner, a CT (Computerized Tomography) X-ray device, or an ETD (Explosives Trace Detector) scanner.

6. The mobile screening system of claim 1,
wherein the mobile screening system includes the plurality of vehicles; and
wherein the plurality of vehicles include at least one people security screening apparatus, at least one carry-on property security screening apparatus, and at least one shipped property security screening apparatus.

7. A mobile screening method comprising:
screening people and their properties which include at least one of carry-on properties or shipped properties, using a mobile screening system which comprises one or more vehicles, (a) if the mobile screening system includes only one vehicle, the vehicle including a plurality of modular screening units built into the vehicle, each modular screening unit being selected from the group consisting of (i) a people security screening apparatus, (ii) a people security screening apparatus and a carry-on property security screening apparatus, and (iii) a shipped property security screening apparatus; (b) if the mobile screening system includes a plurality of vehicles, each vehicle of the plurality of vehicles including one or more modular screening units built into said each vehicle, each modular screening unit being selected from the group consisting of (i) a people security screening apparatus, (ii) a people security screening apparatus and a carry-on property security screening apparatus, and (iii) a shipped property security screening apparatus;
determining whether the people and their properties being screened pass screening;
allowing entry to a secured area for people and their properties that pass the screening; and
denying entry to the secured area for people and their properties that do not pass the screening.

8. The mobile screening method of claim 7, further comprising:
moving the one or more vehicles of the mobile screening system to a temporary security screening area.

9. The mobile screening method of claim 7,
wherein each vehicle comprises one of a land vehicle, an air vehicle.

10. The mobile screening method of claim 7, wherein screening the people and their properties comprises:
admitting the people and their properties into the one or more vehicles through an entrance of each of the one or more vehicles for security screening in the one or more vehicles; and
discharging the people and their properties that are screened and approved from the one or more vehicles through an exit of each of the one or more vehicles to a secured area after passing the security screening.

11. The mobile screening method of claim 8, further comprising one of:
(i) connecting a walkway between an exit of the temporary security screening area and a post-screening destination location for transfer of the screened and approved people and properties to the post-screening destination location, or
(ii) transporting the screened and approved people and properties after exiting from the temporary security screening area using a transport vehicle to a post-screening destination location.

12. The mobile screening method of claim 11,
wherein the post-screening destination location comprises one of a venue, a park, an air travel boarding area, a ground transportation boarding area, a water travel boarding area, an office building, a landmark, or a lodging establishment.

13. The mobile screening method of claim 11, further comprising:
directing the screened and approved people and properties to bypass a permanent security screening area for screening people and properties to the post-screening destination location.

14. The mobile screening method of claim 8, further comprising:
sheltering the people and their properties that are screened and approved in a temporary shelter located between an exit of the temporary security screening area and a post-screening destination location.

15. The mobile screening method of claim 8, further comprising:
notifying in advance the people to be screened of a location of the temporary security screening area.

16. The mobile screening method of claim 8, further comprising:
checking identities of the people being screened;
admitting the people and their properties into the temporary security screening area after verifying their identities; and
denying admission into the temporary security screening area the people and their properties for whom their identities cannot be verified.

17. A mobile screening method comprising:
moving a mobile screening system comprising one or more modular screening vehicles to a temporary security screening area, (a) if the mobile screening system includes only one modular screening vehicle, the modular screening vehicle including a plurality of modular screening units built into the modular screening vehicle, each modular screening unit being selected from the group consisting of (i) a people security screening apparatus, (ii) a people security screening apparatus and a carry-on property security screening apparatus, and (iii) a shipped property security screening apparatus; (b) if the mobile screening system includes a plurality of modular screening vehicles, each modular screening vehicle of the plurality of modular screening vehicles including one of a plurality of modular screening units, each modular screening unit being selected from the group consisting of (i) a people security screening apparatus, (ii) a people security screening apparatus and a carry-on property security screening apparatus, and (iii) a shipped property security screening apparatus;
admitting people and their properties which include at least one of carry-on properties or shipped properties, into the one or more modular screening vehicles through an entrance of each of the one or more modular screening vehicles for security screening in the one or more modular screening vehicles;
screening the people and their properties in the one or more modular screening vehicles using the modular screening units;
discharging the people and their properties that are screened and approved from the one or more modular screening vehicles through an exit of each of the one or more modular screening vehicles to a secured area after passing the security screening; and
denying entry to the secured area for people and their properties that do not pass the security screening.

18. The mobile screening method of claim 17,
wherein each modular screening vehicle comprises one or more of a land vehicle, an air vehicle.

19. The mobile screening method of claim 17, further comprising one of:
(i) connecting a walkway between each exit of the one or more modular screening vehicles and a post-screening destination location for transfer of the screened and approved people and properties to the post-screening destination location, or
(ii) transporting the screened and approved people and properties after exiting from the one or more modular screening vehicles using a transport vehicle to a post-screening destination location.

20. The mobile screening method of claim 19, further comprising:
directing the screened and approved people and properties to bypass a permanent security screening area for screening people and properties to the post-screening destination location.

21. The mobile screening method of claim 20, further comprising:
notifying in advance the people to be screened of a location of the temporary security screening area;
checking identities of the people before admitting the people and their properties into the one or more modular screening vehicles;
admitting the people and their properties into the one or more modular screening vehicles after verifying their identities; and
denying admission into the one or more modular screening vehicles the people and their properties for whom their identities cannot be verified.
